(19) United States
(12) Patent Application Publication
(10) Pub. No.: US 2026/0067584 A1
(43) Pub. Date: Mar. 5, 2026

(54) INFORMATION PROCESSING APPARATUS, CONTROL METHOD FOR THE SAME, AND STORAGE MEDIUM

(71) Applicant: CANON KABUSHIKI KAISHA, Tokyo (JP)

(72) Inventor: TAKAFUMI YANAGISAWA, Tokyo (JP)

(21) Appl. No.: 19/306,873

(22) Filed: Aug. 21, 2025

(30) Foreign Application Priority Data
Aug. 30, 2024 (JP) 2024-148556

(51) Int. Cl. H04N 23/90; G06F 3/0483; H04N 23/661; H04N 23/695

(52) U.S. Cl. CPC H04N 23/90; G06F 3/0483; H04N 23/661; H04N 23/695

(57) ABSTRACT

An information processing apparatus acquires a plurality of video images captured by a plurality of image capturing apparatuses, and controls a display device to display the plurality of video images separately on a plurality of pages by switching the video images on a per-page basis. The plurality of video images include a video image that is displayed on the display device and a video image that is not displayed on the display device. After a first video image, among the plurality of video images and captured by a first image capturing apparatus, is displayed upon switching the pages, the information processing apparatus updates the displayed first video image with a newly acquired video image.

### BACKGROUND

### Field of the Technology

The present disclosure relates to an information processing apparatus, a control method for the information processing apparatus, and a storage medium.

### Description of the Related Art

There are known applications for acquiring a video image captured by a camera via a network and displaying the acquired video image. Some of such applications include a function of displaying video images captured by a plurality of cameras separately on a plurality of pages, with each page including video images of a predetermined number of cameras.

### SUMMARY

In the case of displaying video images separately on a plurality of pages, if video images from cameras to be displayed on a newly displayed page start to be acquired upon switching pages, a time lag may occur before the video images are displayed due to the time required for the acquisition of the video images, which reduces usability. To address such an issue, a technique has been proposed in which video images are constantly acquired in the background even when the video images are hidden, reducing the time lag in the display of video images. However, since those hidden video images are acquired in the background, a large amount of network bandwidth and application resources related to video image processing may be consumed as the number of video images to be acquired from target cameras increases.

The present disclosure is directed to improving usability while reducing the consumption of resources related to video image processing when video images captured by image capturing apparatuses are displayed separately on a plurality of pages.

According to an aspect of the present disclosure, an information processing apparatus acquires a plurality of video images captured by a plurality of image capturing apparatuses, and control a display device to display the plurality of video images separately on a plurality of pages by switching the video images on a per-page basis. The plurality of video images include a video image that is displayed on the display device and a video image that is not displayed on the display device. After a first video image, among the plurality of video images and captured by a first image capturing apparatus, is displayed upon switching the pages, the displayed first video image is updated with a newly acquired video image.

Additional features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration example of a system including an information processing apparatus according to a first exemplary embodiment.

FIG. 2 is a block diagram illustrating a hardware configuration example of an image capturing apparatus.

FIG. 3 is a block diagram illustrating a hardware configuration example of the information processing apparatus.

FIG. 4 illustrates an example of information stored in the image capturing apparatus.

FIG. 5 illustrates an example of information stored in the information processing apparatus.

FIG. 6 is a block diagram illustrating a functional configuration example of the information processing apparatus.

FIG. 7 is a flowchart illustrating an example of processing according to the present exemplary embodiment.

FIG. 8 is a flowchart illustrating an example of processing according to a second exemplary embodiment.

FIG. 9 is a flowchart illustrating an example of processing according to a third exemplary embodiment.

### DESCRIPTION OF THE EMBODIMENTS

Some exemplary embodiments will now be described with reference to the attached drawings. The some embodiments are not limited to the following exemplary embodiments. In the attached drawings, like reference numerals refer to like components, and the redundant description will be omitted. It is on the assumption that the term "page" used in the following exemplary embodiments includes other similar functions, such as a tab. In other words, the term "page" refers to any function of switching and displaying video images by each video image or by each set of video images captured by a plurality of image capturing apparatuses.

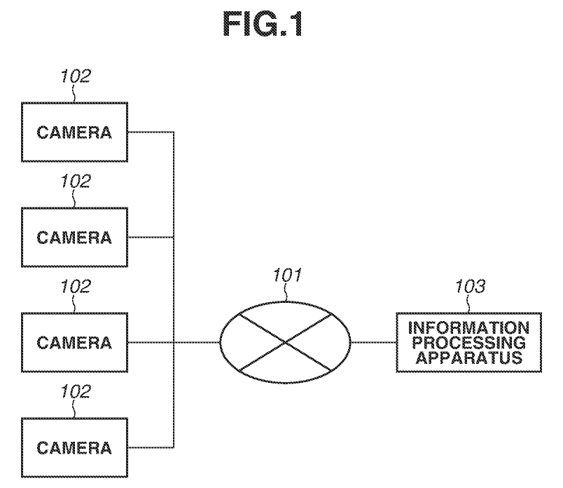

A first exemplary embodiment will now be described. FIG. 1 is a block diagram illustrating a configuration example of a system including an information processing apparatus according to the present exemplary embodiment. The system according to the present exemplary embodiment includes a network 101, cameras 102, and an information processing apparatus 103.

The network 101 communicably connects the cameras 102 and the information processing apparatus 103. The network 101 can be implemented, for example, using a plurality of routers, switches, cables, or the like, in compliance with communication standards, such as Ethernet. The network 101 can be implemented with the Internet, a wired local area network (LAN), a wireless LAN, a wide area network (WAN), or the like.

Each of the cameras 102 is an image capturing apparatus that captures video data (image data and moving image data) through a lens. The system according to the present exemplary embodiment includes a plurality of image capturing apparatuses. In the present exemplary embodiment, each camera 102 is configured to transmit captured video data or the like and a state of the camera 102 to the information processing apparatus 103 in response to a request from the information processing apparatus 103 via the network 101. However, the configuration of each camera 102 is not limited thereto. Each camera 102 may actively transmit video data and the like, for example, at predetermined intervals to the preliminarily connected information processing apparatus 103 and the like.

The information processing apparatus 103 is configured to acquire video data and information from each camera 102 to perform various kinds of processing described below. The information processing apparatus 103 is, for example, an information terminal used as a general client apparatus, such as a personal computer (PC), a tablet, or a smartphone. In the present exemplary embodiment, while an example is described where the information processing apparatus 103 manages the cameras 102, some embodiments are not limited to that example. As a device to be managed, any device can be employed, such as a controller for controlling the cameras or a switching device for switching video images of the cameras, and the like, as long as the device can be controlled via a network.

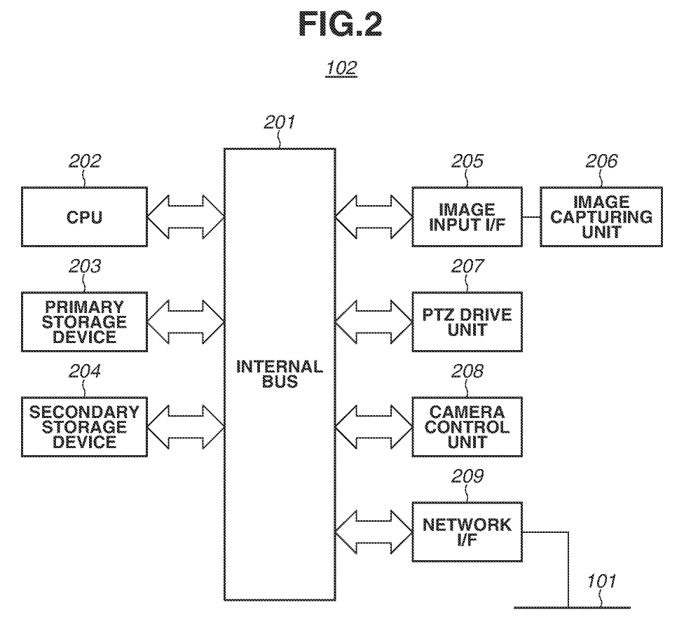

FIG. 2 is a block diagram illustrating a hardware configuration example of each camera 102 according to the present exemplary embodiment.

Each camera 102 includes a central processing unit (CPU) 202, a primary storage device 203, a secondary storage device 204, an image input interface (I/F) 205, an image capturing unit 206, a pan-tilt-zoom (PTZ) drive unit 207, a camera control unit 208, and a network I/F 209. The CPU 202, the primary storage device 203, the secondary storage device 204, the image input I/F 205, the image capturing unit 206, the PTZ drive unit 207, the camera control unit 208, and the network I/F 209 are connected via an internal bus 201.

The CPU 202 generally controls the operation of the camera 102. The primary storage device 203 is, for example, a writable storage device, as typified by a random-access memory (RAM). For example, an operating system (OS), various types of programs, and various kinds of data are loaded into the primary storage device 203. The primary storage device 203 is also used as a working area used when the CPU 202 executes the OS, the various types of programs, and the like.

The secondary storage device 204 is, for example, a non-volatile storage device, as typified by a hard disk drive (HDD), a solid-state drive (SSD), a flash memory, or a secure digital (SD) card. The secondary storage device 204 is used as, for example, a permanent storage area for storing the OS, the various types of programs, various kinds of data, and the like. The secondary storage device 204 can also be used as a short-term storage area for storing the various kinds of data and the like.

The image input I/F 205 inputs image data from the image capturing unit 206. The image capturing unit 206 includes a lens and an image sensor, and captures an image through the lens and the like.

The PTZ drive unit 207 controls motors and the like to cause each camera 102 to perform a pan driving operation, a tilt driving operation, and a zoom driving operation to control the PTZ (pan-tilt-zoom) of each camera 102. The PTZ drive unit 207 may control the PTZ of each camera 102, and also configure settings for each camera 102 and control each camera 102, such as focusing and white balance. A configuration that does not include the PTZ drive unit 207 can be employed, such as a video camera having a zoom function alone or an interchangeable-lens camera having no zoom function.

The camera control unit 208 performs control related to image capturing parameters, such as white balance, focusing, and the like. The camera control unit 208 also performs various types of functions, such as restarting the cameras 102 and performing firmware updates. The network I/F 209 is an interface to connect to the network 101. For example, network communications from the information processing apparatus 103 are transmitted to various types of programs via the network I/F 209.

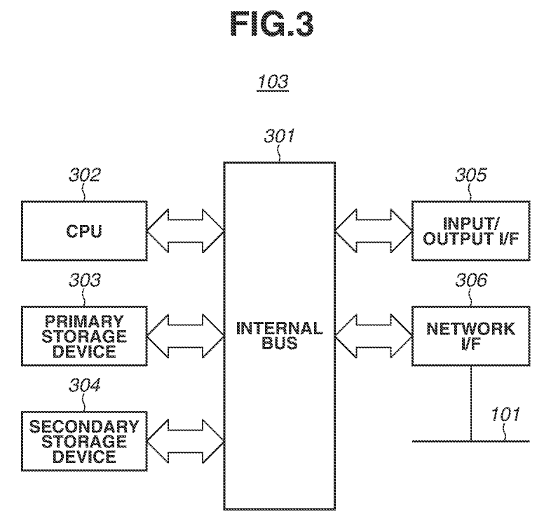

FIG. 3 is a block diagram illustrating a hardware configuration example of the information processing apparatus 103 according to the present exemplary embodiment. The information processing apparatus 103 includes a CPU 302, a primary storage device 303, a secondary storage device 304, an input/output I/F 305, and a network I/F 306. The CPU 302, the primary storage device 303, the secondary storage device 304, the input/output I/F 305, and the network I/F 306 are connected via an internal bus 301.

The CPU 302 is a central processing unit that generally controls the operation of the information processing apparatus 103. The primary storage device 303 is, for example, a writable storage device, as typified by a RAM. For example, an OS, various types of programs, and various kinds of data are loaded into the primary storage device 303. The primary storage device 303 is also used as a working area used when the CPU 302 executes the OS, the various types of programs, and the like.

The secondary storage device 304 is, for example, a non-volatile storage device, as typified by an HDD, an SSD, a flash memory, and an SD card. The secondary storage device 304 is used as, for example, a permanent storage area for storing the OS, the various types of programs, the various kinds of data, and the like. The secondary storage device 304 is also used as a short-term storage area for storing the various kinds of data and the like.

The input/output I/F 305 is an interface via which the information processing apparatus 103 receives operations from a user, inputs user information, and outputs video images and the like to the user. Examples of the input/output I/F 305 include a display, a touch panel, a keyboard, a mouse, and a microphone. In this case, the touch panel and the display may be configured as an integrated unit, such as a touch panel-equipped display capable of detecting touch positions. These I/Fs are used in touch and mouse operations, voice input, processing using captured images, and the like. The network I/F 306 is an interface to connect to the network 101. For example, network communications from the cameras 102 are transmitted to various types of programs via the network I/F 306.

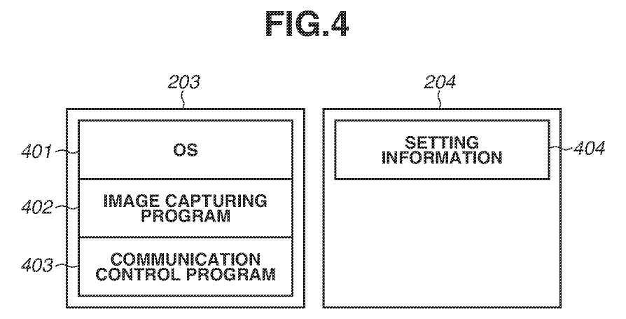

FIG. 4 illustrates an example of information stored in each camera 102. FIG. 4 illustrates an example of various types of programs, various kinds of data, and the like stored in the primary storage device 203 and the secondary storage device 204 in each camera 102. An OS 401, an image capturing program 402, and a communication control program 403 are loaded into the primary storage device 203. The secondary storage device 204 stores setting information 404. The secondary storage device 204 also stores the various types of programs (the OS 401, the image capturing program 402, and the communication control program 403) loaded into the primary storage device 203.

The OS 401 is a basic program to control the operation of the entire camera 102. For example, the OS 401 manages the position (the address) and the size of each of the various types of programs (the image capturing program 402 and the communication control program 403), the various kinds of data (the setting information 404), and the like in the primary storage device 203 and the secondary storage device 204. The image capturing program 402 acquires images captured by the image capturing unit 206 via the image input I/F 205 in response to image acquisition requests from the information processing apparatus 103, instructions from another program, and the like. The image capturing program 402 may convert the acquired images into image data in a joint photographic experts group (JPEG) format or moving image data in H.264 or the like.

The communication control program 403 controls the communication performed with the information processing apparatus 103 from the network I/F 209 via the network 101. Examples of the communication content include receiving acquisition requests for images captured by the image capturing unit 206, and receiving PTZ control requests for the PTZ drive unit 207 of each camera 102. Requests from the information processing apparatus 103 can be received using, for example, a general communication protocol, such as a HyperText Transfer Protocol (HTTP).

The setting information 404 includes, for example, setting values, such as an Internet Protocol (IP) address used in communication performed by the communication control program 403, and is stored in the secondary storage device 204 of each camera 102.

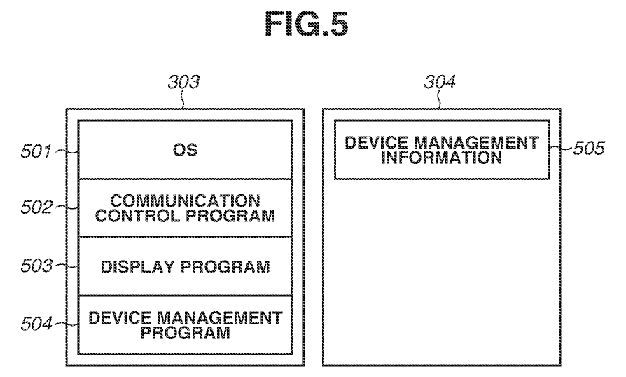

FIG. 5 illustrates an example of information stored in the information processing apparatus 103. FIG. 5 illustrates various types of programs, various kinds of data, and the like stored in the primary storage device 303 and the secondary storage device 304 of the information processing apparatus 103. An OS 501, a communication control program 502, a display program 503, and a device management program 504 are loaded into the primary storage device 303. The secondary storage device 304 stores device management information 505. The secondary storage device 304 also stores the various types of programs (the OS 501, the communication control program 502, the display program 503, and the device management program 504) loaded into the primary storage device 303. In the present exemplary embodiment, the device management information 505 is stored in the secondary storage device 304, but can be stored in the primary storage device 303 as temporary information.

The OS 501 is a basic program to control the operation of the entire information processing apparatus 103. In this case, for example, the OS 501 manages the position (the address) and the size of each of the various types of programs (the communication control program 502, the display program 503, and the device management program 504), the various kinds of data (the device management information 505), and the like in the primary storage device 303 and the secondary storage device 304. The communication control program 502 controls the communication performed with each camera 102 from the network I/F 306 via the network 101. Examples of the communication content include transmitting acquisition requests for images captured by the image capturing unit 206 of each camera 102, and transmitting PTZ control requests for the PTZ drive unit 207 of each camera 102. Requests to be transmitted to each camera 102 can be issued using, for example, a general communication protocol, such as a HTTP.

The display program 503 is used to display data about video images acquired from the cameras 102, icons for controlling the cameras 102, and the like on a display device, which is one example of the input/output I/F 305 included in the information processing apparatus 103. Further, the display program 503 can receive inputs from an external device, such as a mouse or a keyboard, and inputs of touch operations or the like as user inputs in a case where the display device is a touch display or the like, to issue instruction to execute various types of functions of the cameras 102 based on those inputs. In a case where a plurality of the cameras 102 displays video images, the display program 503 can use a page switching function to switch and display the video images on a plurality of pages by separating the video images into the plurality of pages for a predetermined number of the cameras. Instead of using the page switching function, video images from the cameras to be displayed can be switched by scrolling. For example, a number can be assigned to each camera 102, and video images from the camera numbered one to four can be displayed on the first page, while video images from the camera numbered five to eight can be displayed on the second page.

The device management program 504 manages information about a state of each camera 102, information about connections to each camera 102, and the like related to the plurality of the cameras 102 connected to the system. The device management program 504 stores, for example, the information subject to management in the secondary storage device 304 as the device management information 505 described below. The device management information 505 is information related to devices to be managed, which is generated by the device management program 504. The device management information 505 includes information used to connect to each camera 102, including an IP address, a display position of each camera 102, and page information to be used by the display program 503.

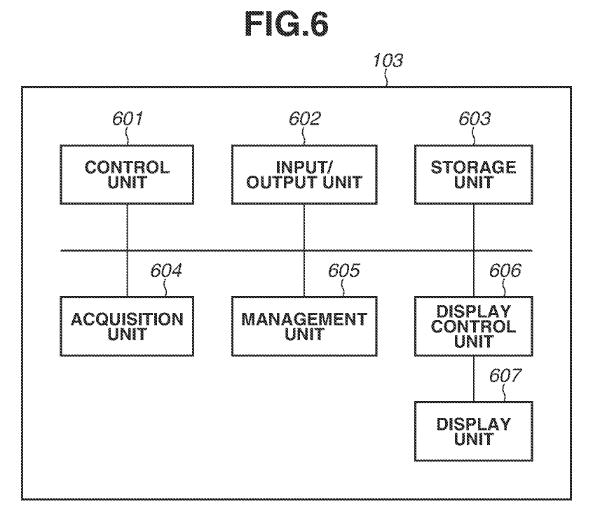

FIG. 6 is a block diagram illustrating a functional configuration example of the information processing apparatus 103 according to the present exemplary embodiment. The information processing apparatus 103 includes a control unit 601, an input/output unit 602, a storage unit 603, an acquisition unit 604, a management unit 605, a display control unit 606, and a display unit 607.

The control unit 601 generally controls the operation of the information processing apparatus 103. For example, the control unit 601 controls the acquisition of video data, information about states of each camera 102, and the like from each camera 102 performed by the acquisition unit 604, and controls the display of video images of each camera 102 performed by the display control unit 606. The control unit 601 also performs PTZ control processing to control the PTZ position of each camera 102 based on inputs or the like received from the user via the input/output unit 602.

For example, the input/output unit 602 receives inputs of user operations from the user, and outputs various kinds of information to the user. The storage unit 603 stores various types of programs, various kinds of data, and the like for the information processing apparatus 103 to execute various types of processing. The storage unit 603 stores, for example, the video data acquired from the cameras 102 by the acquisition unit 604, and the device management information generated by the management unit 605.

The acquisition unit 604 acquires video data, information about a state of each camera 102, and the like from each camera 102 under the control of the control unit 601. The acquired video data, the acquired information about a state of each camera 102, and the like are stored in, for example, the storage unit 603. The management unit 605 manages the state of each camera 102 and the information about connections to each camera 102 of the plurality of cameras 102 connected to the system. The management unit 605 generates system management information to manage these pieces of information. The generated system management information is stored in, for example, the storage unit 603. The system management information includes information about pages on which video images from each of the plurality of cameras 102 connected to the system are to be displayed by using the page switching function. Based on this information, for example, the management unit 605 can manage the display and non-display states of each camera 102 when video images of the cameras 102 are to be displayed using the page switching function.

The display control unit 606 controls the display unit 607 to display video data about the cameras 102 and display icons and the like for controlling the cameras 102. For example, the display control unit 606 controls the display unit 607 to display video data that is acquired by the acquisition unit 604 and stored in the storage unit 603 as video images of each camera 102.

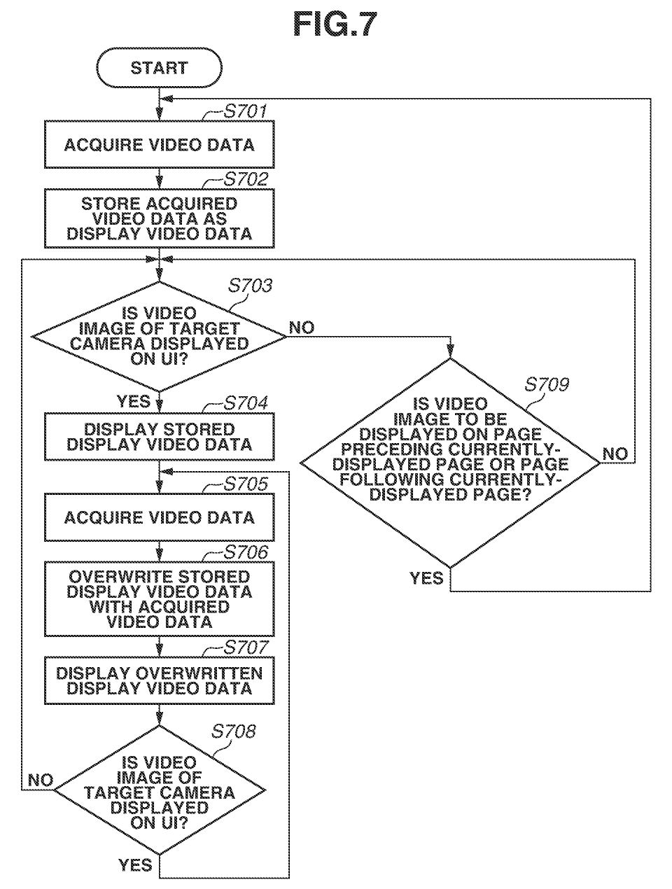

FIG. 7 is a flowchart illustrating an example of processing performed by the information processing apparatus 103 according to the present exemplary embodiment. The processing of the flowchart illustrated in FIG. 7 is performed, for example, by the CPU 302 of the information processing apparatus 103 executing various types of programs or the like including the display program 503 loaded into the primary storage device 303. FIG. 7 illustrates an example of processing for the information processing apparatus 103 to acquire a video image from one of the cameras 102 (the target camera 102) connected via the network 101. The information processing apparatus 103 performs the processing of the flowchart illustrated in FIG. 7 on each camera 102 connected via the network 101.

In step S701, the control unit 601 of the information processing apparatus 103 acquires the device management information 505 stored in the storage unit 603 to acquire camera information about the target camera 102 from which the video image is to be acquired based on the acquired device management information 505. The control unit 601 then causes the acquisition unit 604 to acquire video data from the target camera 102 based on the acquired camera information. In this case, if the plurality of cameras 102 is set as the target cameras 102, a plurality of video images captured by the plurality of cameras 102 is acquired. The device management information 505 is generated by the management unit 605 and stored in the storage unit 603. In this case, if a video image is already being displayed, the currently-displayed video image of the camera 102 is continuously acquired. Further, the video image of the camera 102 displayed on the preceding page or the following page of the currently-displayed page is also continuously acquired. The preceding and following pages of the currently-displayed page can each be switched by a single click in many cases. Thus, since the pages can be switched with a small amount of operation, the video image is acquired in advance. The video image to be displayed either on the preceding page or the following page alone of the currently-displayed page can be acquired. Thus, the video images acquired by the acquisition unit 604 include video images that are being displayed on the display unit 607 and video images that are not being displayed on the display unit 607. In other words, the acquisition of video images that are not being displayed on the display unit 607 is started in advance.

In step S702, the control unit 601 stores the video data acquired from the target camera 102 in step S701 in the storage unit 603 as display video data related to the camera 102. If the video data acquired from the target camera 102 is already stored in the storage unit 603 as the display video data related to the camera 102, the display control unit 606 overwrites the stored video data with the video data acquired in step S701.

In step S703, the control unit 601 determines whether the video image of the target camera 102 is displayed on a user interface (UI) for displaying camera video images, which is displayed on the display unit 607 by the display control unit 606. For example, the control unit 601 determines whether the video image of the target camera 102 is newly displayed upon switching the pages. If the control unit 601 determines that the video image of the target camera 102 is displayed on the UI (YES in step S703), the processing proceeds to step S704. On the other hand, if the control unit 601 determines that the video image of the target camera 102 is not displayed on the UI (NO in step S703), the processing proceeds to step S709. The term "UI" used herein includes a display screen to display each video image. The UI according to the exemplary embodiments can simply be a screen for displaying a video image.

In step S704, the display control unit 606 displays the display video data about the target camera 102 stored in the storage unit 603 on the UI as the video image of the camera 102.

In step S705, the control unit 601 causes the acquisition unit 604 to acquire video data from the target camera 102 based on the acquired camera information. In other words, the video image of the camera 102 to be switched from a non-display target to a display target upon switching the pages is continuously acquired. The video image to be acquired in this case is, for example, currently captured video data or currently distributed video data.

In step S706, the display control unit 606 overwrites (updates) the display video data about the target camera 102 stored in the storage unit 603 with the video data acquired from the target camera 102 in step S705.

In step S707, the display control unit 606 displays the display video data about the target camera 102, which has been overwritten in step S706, on the UI as the video image of the camera 102.

In step S708, the control unit 601 determines whether the video image of the target camera 102 is displayed on the UI for displaying video images of the camera. If the control unit 601 determines that the video image of the target camera 102 is displayed on the UI (YES in step S708), the processing returns to step S705. Thus, the processing of steps S705 to S707 is repeatedly performed while the video image of the target camera 102 is being displayed on the UI. In other words, the currently acquired video image is continuously displayed. Further, the video image stored in the storage unit 603 is maintained as the most recently acquired video image. On the other hand, if the control unit 601 determines that the video image of the target camera 102 is not being displayed on the UI (NO in step S708), the processing returns to step S703.

In step S709, the control unit 601 determines, based on the device management information 505, whether the video image of the target camera 102 is to be displayed on the preceding page or the following page of the currently-displayed page (the displayed page) in the page switching function. In other words, the control unit 601 determines whether the video image of the target camera 102 is to be displayed on either the previous page or the next page relative to the currently-displayed page (the displayed page). If the control unit 601 determines that the video image of the target camera 102 is to be displayed on the preceding page or the following page of the currently-displayed page (the displayed page) (YES in step S709), the processing returns to step S701. Then, the processing of steps S701 and S702 is performed to overwrite the display video data about the target camera 102 stored in the storage unit 603 with the video data acquired from the target camera 102. On the other hand, if the control unit 601 determines that the video image of the target camera 102 is not to be displayed on the preceding page or the following page of the currently-displayed page (the displayed page) (NO in step S709), the processing returns to step S703. In this manner, the control unit 601 determines that it is highly likely that the video images of the camera 102 corresponding to the preceding page or the following page of the current page are to be actually displayed upon switching the pages. Then, the control unit 601 controls these video images to be acquired in advance. The video image to be displayed on either the preceding page or the following page alone of the currently-displayed page can be acquired.

As described above, according to the present exemplary embodiment, the information processing apparatus 103 first acquires video data from the camera 102 and then switches between acquiring and not acquiring the video image based on whether the video image of the camera 102 is being displayed on the UI. This processing enables video data to be displayed immediately upon a change in the display state of the camera 102 due to a page switch without constantly acquiring the video image of the camera 102 when the video images of the cameras 102 are displayed separately on a plurality of pages. This configuration makes it possible to improve the usability while reducing the consumption of network bandwidth and application resource related to video image processing in a case where video images of the cameras are displayed separately on a plurality of pages.

If the video image of the target camera 102 is displayed on the preceding page or the following page of the currently-displayed page (the display page), the processing returns to step S701 to acquire video image from the target camera 102 and overwrite the display video data with the acquired video data. This makes it possible to improve usability while reducing the consumption of network bandwidth and application resource related video processing in displaying video images of the cameras 102 are displayed on a plurality of pages.

In the example described above, if the video image of the target camera 102 is to be displayed on the preceding page or the following page of the currently-displayed page (the displayed page) in step S709, the processing returns to step S701 to acquire video data from the target camera 102 and overwrite the display video data with the acquired video data. However, the present exemplary embodiment is not limited to this example.

For example, if the video image of the target camera 102 is to be displayed in a top row on the preceding page or the following page of the currently-displayed page (the displayed page), the processing may return to step S701 to acquire video data from the target camera 102 and overwrite the display video data with the acquired video data. In this manner, the network bandwidth necessary for the communication can be reduced, resulting in less resource consumption than when video images are acquired of all the cameras 102 to be displayed on the preceding page or the following page. Further, video images of some of the cameras 102 to be displayed can be displayed with no time lag upon switching the pages, which leads to an improvement in usability.

For example, when a predetermined time has elapsed since the acquisition of the last video image of the camera 102, the processing may return to step S701 to acquire video data from the camera 102 and overwrite the display video image with the acquired video data. This configuration can prevent too old video images from being displayed upon starting to display a video image due to a page switch.

For example, if the resolution of the video image captured by the camera 102 is higher than a predetermined resolution, the processing may return to step S701 to acquire video data from the camera 102 and overwrite the display video data with the acquired video data. Generally, in the case of acquiring a video image with a high resolution, it may take a longer time to acquire video data. However, in the present exemplary embodiment, the time required to display the video image upon switching the pages can be reduced, which leads to an improvement in usability.

A second exemplary embodiment will now be described. The second exemplary embodiment differs from the first exemplary embodiment described above in processing to be performed by the information processing apparatus 103. The other configurations in the present exemplary embodiment are similar to those of the first exemplary embodiment. Thus, the processing performed by the information processing apparatus 103 according to the present exemplary embodiment will be described in the following. The present exemplary embodiment can be combined with the first exemplary embodiment.

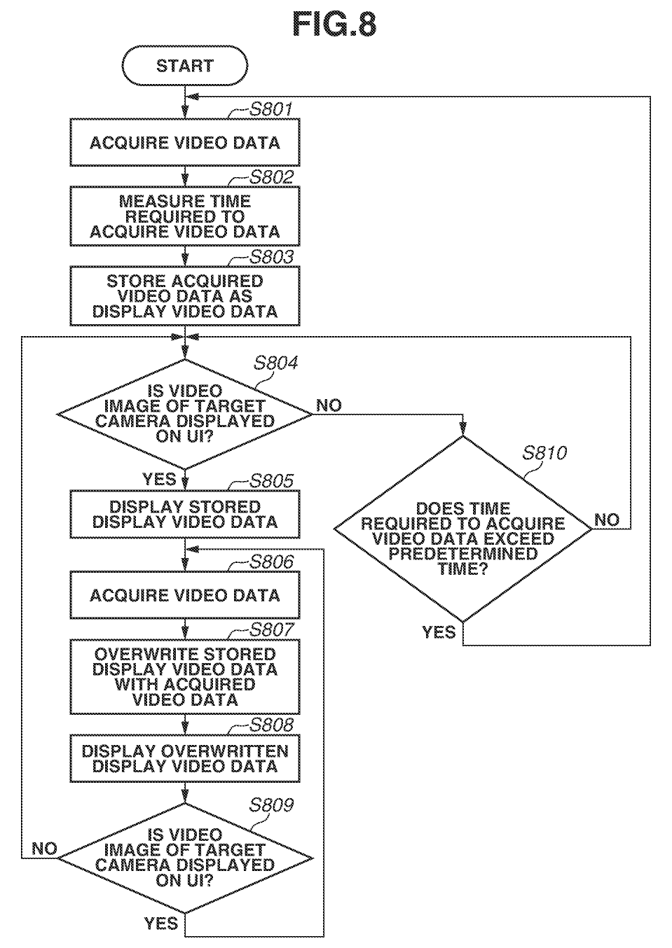

FIG. 8 is a flowchart illustrating an example of the processing performed by the information processing apparatus 103 according to the present exemplary embodiment. The processing of the flowchart illustrated in FIG. 8 is performed, for example, by the CPU 302 of the information processing apparatus 103 executing various types of programs or the like including the display program 503 loaded into the primary storage device 303. FIG. 8 illustrates an example of processing for the information processing apparatus 103 to acquire a video image from one of the cameras 102 (the target camera 102) connected via the network 101. The information processing apparatus 103 executes the processing of the flowchart illustrated in FIG. 8 on each camera 102 connected via the network 101.

In step S801, the control unit 601 of the information processing apparatus 103 acquires camera information about the target camera 102 and causes the acquisition unit 604 to acquire video data from the target camera 102 based on the acquired camera information in the same manner as in step S701 illustrated in FIG. 7.

In step S802, the control unit 601 measures the time required to acquire video data from the target camera 102 in step S801. Specifically, the control unit 601 measures the round trip time for acquiring video data from the target camera 102. The time required to acquire video data, which is obtained by the measurement, is stored as the device management information 505 by the management unit 605.

In step S803, the control unit 601 stores the video data acquired from the target camera 102 in step S801 in the storage unit 603 as display video data related to the camera 102. If the video data acquired from the target camera 102 is already stored in the storage unit 603 as the display video data related to the camera 102, the display control unit 606 overwrites the stored video data with the video data acquired in step S801.

In step S804, the control unit 601 determines whether the video image of the target camera 102 is to be displayed on the UI for displaying camera video images to be displayed on the display unit 607 by the display control unit 606. For example, the control unit 601 determines whether the video image of the target camera 102 is to be newly displayed upon switching the pages. If the control unit 601 determines that the video image of the target camera 102 is to be displayed on the UI (YES in step S804), the processing proceeds to step S805. On the other hand, if the control unit 601 determines that the video image of the target camera 102 is not to be displayed on the UI (NO in step S804), the processing proceeds to step S810.

In step S805, the display control unit 606 displays the display video data about the target camera 102 stored in the storage unit 603 on the UI as the video image of the camera 102.

In step S806, the control unit 601 causes the acquisition unit 604 to acquire video data from the target camera 102 based on the acquired camera information. In other words, the video image of the camera 102 to be switched from the non-display target to the display target upon switching the pages is continuously acquired. The video data to be acquired here is, for example, currently captured video data or currently distributed video data.

In step S807, the display control unit 606 overwrites the display video data about the target camera 102 stored in the storage unit 603 with the video data acquired from the target camera 102 in step S806.

In step S808, the display control unit 606 displays the display video data about the target camera 102, which has been overwritten in step S807, on the UI as the video image of the camera 102.

In step S809, the control unit 601 determines whether the video image of the target camera 102 is displayed on the UI for displaying the video image of the camera. If the control unit 601 determines that the video image of the target camera 102 is being displayed on the UI (YES in step S809), the processing returns to step S806. Thus, the processing of steps S806 to S808 described above is repeatedly performed while the video image of the target camera 102 is being displayed on the UI. On the other hand, if the control unit 601 determines that the video image of the target camera 102 is not being displayed on the UI (NO in step S809), the processing returns to step S804.

In step S810, the control unit 601 determines whether the time required to acquire the video image of the target camera 102, which has been measured in step S802, exceeds a predetermined time based on the device management information 505. If the control unit 601 determines that the time required to acquire the video image of the target camera 102 exceeds the predetermined time (YES in step S810), the processing returns to step S801.

The processing of steps S801 to S803 is then performed and the display video data about the target camera 102 stored in the storage unit 603 is overwritten with the video data acquired from the target camera 102. On the other hand, if the control unit 601 determines that the time required to acquire the video image of the target camera 102 does not exceed the predetermined time (NO in step S810), the processing returns to step S804. Thus, the video image of the camera 102 that is determined to exceed the predetermined time starts to be acquired in advance even when the video image is not displayed on the display unit 607.

As described above, according to the present exemplary embodiment, the information processing apparatus 103 acquires video data depending on the time required to acquire the video image of the camera 102 even when the video image of the camera 102 is not being displayed on the UI.

This configuration makes it possible to immediately start displaying the video image upon switching the pages while reducing the consumption of the network bandwidth, which leads to an improvement in usability.

A third exemplary embodiment will now be described. The present exemplary embodiment differs from the first exemplary embodiment described above in processing performed by the information processing apparatus 103. The other configurations of the present exemplary embodiment are similar to those of the first exemplary embodiment. Thus, the processing performed by the information processing apparatus 103 according to the present exemplary embodiment will be described. The present exemplary embodiment can be combined with the first exemplary embodiment and the second exemplary embodiment.

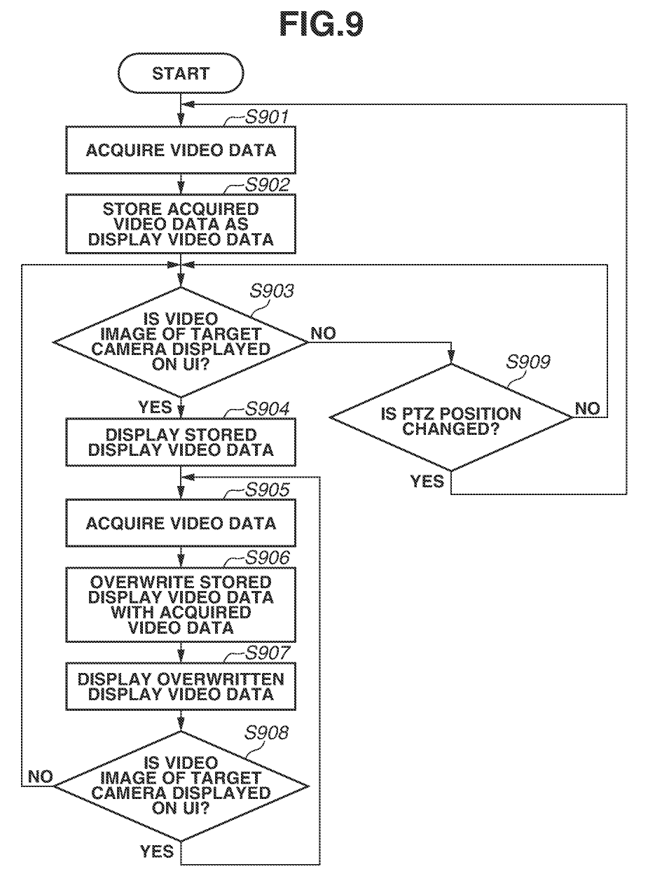

FIG. 9 is a flowchart illustrating an example of processing performed by the information processing apparatus 103 according to the present exemplary embodiment. The processing of the flowchart illustrated in FIG. 9 is performed, for example, by the CPU 302 of the information processing apparatus 103 executing various types of programs or the like including the display program 503 loaded into the primary storage device 303. FIG. 9 illustrates an example of processing for the information processing apparatus 103 to acquire a video image from one of the cameras 102 (the target camera 102) connected via the network 101. The information processing apparatus 103 performs the processing of the flowchart illustrated in FIG. 9 on each camera 102 connected via the network 101.

In step S901, the control unit 601 of the information processing apparatus 103 acquires camera information about the target camera 102 and causes the acquisition unit 604 to acquire video data from the target camera 102 based on the acquired camera information in the same manner as in step S701 illustrated in FIG. 7.

In step S902, the control unit 601 stores the video data acquired from the target camera 102 in step S901 in the storage unit 603 as display video data related to the camera 102. If the video data acquired from the target camera 102 is already stored in the storage unit 603 as the display video data related to the camera 102, the display control unit 606 overwrites the stored video data with the video data acquired in step S901.

In step S903, the control unit 601 determines whether the video image of the target camera 102 is displayed on the UI for displaying the video image of the camera to be displayed on the display unit 607 by the display control unit 606. For example, the control unit 601 determines whether the video image of the target camera 102 is newly displayed upon switching the pages. If the control unit 601 determines that the video image of the target camera 102 is to be displayed on the UI (YES in step S903), the processing proceeds to step S904. On the other hand, if the control unit 601 determines that the video image of the target camera 102 is not to be displayed on the UI (NO in step S 903), the processing proceeds to step S909.

In step S904, the display control unit 606 displays the display video data about the target camera 102 stored in the storage unit 603 on the UI as the video image of the camera 102.

In step S905, the control unit 601 causes the acquisition unit 604 to acquire video data from the target camera 102 based on the acquired camera information. In other words, the video image of the camera 102 to be switched from the non-display target to the display target upon switching the pages is continuously acquired. The video data to be acquired here is, for example, currently captured video data or currently distributed video data.

In step S906, the display control unit 606 overwrites the display video data about the target camera 102 stored in the storage unit 603 with the video data acquired from the target camera 102 in step S905.

In step S907, the display control unit 606 displays the display video data about the target camera 102, which has been overwritten in step S906, on the UI as the video image of the camera 102.

In step S908, the control unit 601 determines whether the video image of the target camera 102 is being displayed on the UI for displaying camera video images. If the control unit 601 determines that the video image of the target camera 102 is being displayed on the UI (YES in step S908), the processing returns to step S905. Thus, the processing of steps S905 to S907 is repeatedly performed while the video image of the target camera 102 is being displayed on the UI. On the other hand, if the control unit 601 determines that the video image of the target camera 102 is not being displayed on the UI (NO in step S908), the processing returns to step S903.

In step S909, the control unit 601 determines whether PTZ control processing is performed on the target camera 102 and the PTZ position of the camera 102 is changed. If at least one of the pan, tilt, and zoom positions of the target camera 102 is changed, the control unit 601 determines that the PTZ position is changed. If the control unit 601 determines that the PTZ position of the target camera 102 is changed (YES in step S909), the processing returns to step S901. Then, the processing of steps S901 and S902 is executed and the display video data about the target camera 102 stored in the storage unit 603 is overwritten with the video data acquired from the target camera 102. On the other hand, if the control unit 601 determines that the PTZ position of the target camera 102 is not changed (NO in step S909), the processing returns to step S903. Thus, the video image from the camera 102 whose PTZ position is determined to have been changed starts to be acquired in advance even when the video image is not displayed on the display unit 607.

As described above, according to the present exemplary embodiment, the information processing apparatus 103 acquires video data if the PTZ position of the camera 102 has been changed even in a case where the video image of the camera 102 is not being displayed on the UI. This configuration makes it possible to immediately start display of a video image while preventing a video image with a different angle of view due to a difference in PTZ position from being displayed upon switching the pages, which leads to an improvement in usability.

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

The above-described exemplary embodiments are merely specific examples for implementing the present disclosure. The present disclosure should not be interpreted in a limited manner through the exemplary embodiments. Thus, the present disclosure can be implemented in various forms without departing from the technical idea or the main features thereof.

The disclosure of the exemplary embodiments includes the following configurations, methods, and the like.

### (Configuration 1)

An information processing apparatus comprising: an acquisition unit configured to acquire a plurality of video images captured by a plurality of image capturing apparatuses; a storage unit configured to store the plurality of video images acquired by the acquisition unit; and a display control unit configured to control a display unit to display the plurality of video images separately on a plurality of pages by switching the video images on a per-page basis, wherein the plurality of video images includes a video image displayed on the display unit and a video image hidden on the display unit, and wherein in a case where it is determined that a video image captured by a first image capturing apparatus among the plurality of video images is to be displayed upon switching the pages, the display control unit causes the display unit to display the video image stored in the storage unit and captured by the first image capturing apparatus, and then updates the video image displayed on the display unit and captured by the first image capturing apparatus with a video image newly acquired by the acquisition unit.

### (Configuration 2)

The information processing apparatus according to configuration 1, further comprising a control unit configured to cause the acquisition unit to acquire the video image captured by the first image capturing apparatus while the video image captured by the first image capturing apparatus is being displayed, and configured to overwrite the video image of the first image capturing apparatus stored in the storage unit with the acquired video image.

### (Configuration 3)

The information processing apparatus according to configuration 1 or 2, further comprising a control unit configured to control the acquisition unit to acquire a video image captured by the image capturing apparatus to be displayed on a preceding page or a following page of the currently-displayed page among the plurality of pages, and configured to overwrite the video image of the image capturing apparatus stored in the storage unit.

### (Configuration 4)

The information processing apparatus according to configuration3, further comprising a control unit configured to control the acquisition unit to acquire a video image of the image capturing apparatus to be displayed in a top row on the preceding page or the following page among video images of the image capturing apparatuses to be displayed on the preceding page or the following page.

### (Configuration 5)

The information processing apparatus according to any one of configurations 1 to 4, further comprising a control unit configured to control the acquisition unit to acquire a video image captured by the image capturing apparatus after a lapse of a predetermined time from the acquisition of the video images by the acquisition unit, and to overwrite the video image of the image capturing apparatus stored in the storage unit with the acquired video image.

### (Configuration 6)

The information processing apparatus according to any one of configurations 1 to 5, further comprising a control unit configured to control the acquisition unit to acquire a video image from the image capturing apparatus with a resolution higher than a predetermined resolution among the plurality of image capturing apparatuses, and to overwrite the video image of the image capturing apparatus stored in the storage unit with the acquired video image.

### (Configuration 7)

The information processing apparatus according to any one of configurations 1 to 6, further comprising a control unit configured to control the acquisition unit to acquire a video image from the image capturing apparatus with time for acquiring the captured video image exceeding a predetermined time among the plurality of image capturing apparatuses, and to overwrite the video image of the image capturing apparatus stored in the storage unit with the acquired video image.

### (Configuration 8)

The information processing apparatus according to any one of configurations 1 to 7, further comprising a control unit configured to control the acquisition unit to acquire a video image from the image capturing apparatus with at least one of pan, tilt, and zoom positions in the image capturing apparatus having being changed among the plurality of image capturing apparatuses, and to overwrite the video image of the image capturing apparatus stored in the storage unit with the acquired video image.

### (Method)

A control method for an information processing apparatus, the control method comprising: acquiring a plurality of video images captured by a plurality of image capturing apparatuses; storing the plurality of acquired video images in a storage unit; and controlling a display unit to display the plurality of video images separately on a plurality of pages by switching the plurality of video images on a per-page basis, wherein the plurality of video images includes a video image displayed on the display unit and a video image hidden on the display unit, and wherein in a case where it is determined that a video image captured by a first image capturing apparatus among the plurality of video images is displayed upon switching the pages, in the display controlling, the display unit is caused to display the video image stored in the storage unit and captured by the first image capturing apparatus, and then the video image displayed on the display unit and captured by the first image capturing apparatus is updated with a video image newly acquired.

### (Program)

A non-volatile storage medium storing a program for causing a computer to execute processing comprising: acquiring a plurality of video images captured by a plurality of image capturing apparatuses; storing the plurality of acquired video images in a storage unit; and controlling a display unit to display the plurality of video images separately on a plurality of pages by switching the plurality of video images on a per-page basis, wherein the plurality of video images includes a video image displayed on the display unit and a video image hidden on the display unit, and wherein in a case where it is determined that a video image captured by a first image capturing apparatus among the plurality of video images is displayed upon switching the pages, in the display controlling, the display unit is caused to display the video image stored in the storage unit and captured by the first image capturing apparatus, and then the video image displayed on the display unit and captured by the first image capturing apparatus is updated with a video image newly acquired.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-148556, which was filed on August 30, 2024 and which is hereby incorporated by reference herein in its entirety.

What is claimed is:

1. An information processing apparatus comprising:
one or more memories storing instructions; and
one or more processors executing the instructions to:
acquire a plurality of video images captured by a plurality of image capturing apparatuses; and
control a display device to display the plurality of video images separately on a plurality of pages by switching the video images on a per-page basis, the plurality of video images including a video image that is displayed on the display device and a video image that is not displayed on the display device,
wherein, after a first video image, among the plurality of video images and captured by a first image capturing apparatus, is displayed upon switching the pages, the displayed first video image is updated with a newly acquired video image.

2. The information processing apparatus according to claim 1,. a new video image captured by the first image capturing apparatus is acquired while the first video image is being displayed.

3. The information processing apparatus according to claim 1, wherein a video image, captured by the first image capturing apparatus, to be displayed on a preceding page or a following page of the currently-displayed page among the plurality of pages is acquired.

4. The information processing apparatus according to claim 3, wherein a video image, captured by the first image capturing apparatus, to be displayed in a top row on the preceding page or the following page, among video images of the plurality of video images, captured by the plurality of image capturing apparatuses, to be displayed on the preceding page or the following page is acquired.

5. The information processing apparatus according to claim 1, wherein a video image captured, by the first image capturing apparatus, after a lapse of a predetermined time from the acquisition of the plurality of video images is acquired.

6. The information processing apparatus according to claim 1, wherein a video image, captured by an image capturing apparatus, among the plurality of image capturing apparatuses, with a resolution higher than a predetermined resolution is acquired.

7. The information processing apparatus according to claim 1, wherein a video image from an image capturing apparatus, among the plurality of image capturing apparatuses, with time for acquiring the video image exceeding a predetermined time is acquired.

8. The information processing apparatus according to claim 1, wherein a video image from an image capturing apparatus, among the plurality of image capturing apparatuses, with at least one of pan, tilt, and zoom positions in the image capturing apparatus having being changed is acquired.

9. A control method for an information processing apparatus comprising:
acquiring a plurality of video images captured by a plurality of image capturing apparatuses; and
controlling a display device to display the plurality of video images separately on a plurality of pages by switching the plurality of video images on a per-page basis, the plurality of video images including a video image that is displayed on the display device and a video image that is not displayed on the display device,
wherein, after a first video image, among the plurality of video images and captured by a first image capturing apparatus, is displayed upon switching the pages, the displayed first video image is updated with a newly acquired video image.

10. A non-volatile storage medium storing a program for causing a computer to execute processing comprising:
acquiring a plurality of video images captured by a plurality of image capturing apparatuses; and
controlling a display device to display the plurality of video images separately on a plurality of pages by switching the plurality of video images on a per-page basis, the plurality of video images including a video image that is displayed on the display device and a video image that is not displayed on the display device,
wherein, after a first video image, among the plurality of video images and captured by a first image capturing apparatus, is displayed upon switching the pages, the displayed first video image is updated with a newly acquired video image.
